(19) United States
(12) Patent Application Publication
(10) Pub. No.: US 2003/0209386 A1
(43) Pub. Date: Nov. 13, 2003

(54) Hand-held footstep, handgrip, prybar, wire roll holder, nail puller

(76) Inventor: Michael Bruce Lackey, Colorado Springs, CO (US)

Correspondence Address: MICHAEL B. LACKEY, 14455 ROLLERCORSTER ROAD, COLORADO SPRINGS, CO, 80921, US

(21) Appl. No.: 10/141,812

(22) Filed: May 9, 2002

(51) Int. Cl. E06C 9/00

(52) U.S. Cl. 182/92

(57) ABSTRACT

A multiple function handtool device which consolidates a number of equipment and tool requirements for framing, electrical, plumbing, and mechanical construction or maintenance tasks on wood frame building structures equipment into a single compact handtool. The device slides onto and grips a standard dimension 1½ inch wood wall stud or joist. Inplace, the device is a quick, efficient, inexpensive, alternative to a stepladder, scaffold or other means of increasing overhead reach. Second, it provides a safety handgrip for the user of a ladder, scaffold or other such vertical conveyance. Third, it can be used as a come-along or prybar on any building material with a 1½ inch dimension such as studs and joists. Inserting a length of pipe into the step/grip enhances this feature. Fourth, when fitted with a length of pipe, the device serves as a wire roll spool holder for dispensing wire. Last, when used with the step/grip as a handle and the V-shape notch in the jaw face, the device serves as a nail puller and wire insulation stripper.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to the problem of requiring separate specialized and often cumbersome equipment or tools to perform framing, electrical, plumbing, and mechanical construction or maintenance tasks on wood frame building structures. This multiple function invention consolidates the requirements for a stepladder or scaffold, handgrip, prybar or come-along, wire roll holder and dispenser, nail puller and wire insulation stripper into a single small handtool. It is lightweight and fits handily on or in a workman's toolbelt, providing quick access.

There are a number of inventions that singularly address the requirements above, but are more complicated in design or operation. None offer multifunctions in a single, simple, handheld device. U.S. Pat. No. 4,696,372 discloses the use of a spring-loaded gripping device which functions as a stepping device. Although effective, it is more complicated, heavy and cumbersome than the proposed invention. U.S. Pat. No. 3,561,563 discloses another stepping device which is only designed for access from one side of the stud. None of these devices offer the functional diversity or simplicity of this invention.

### SUMMARY OF THE INVENTION

This invention is made of steel or alloy. It is approximately seven inches in overall length, two inches in height and is comprised of a footstep/handgrip, slipguard and jaw. It grips a standard 1½ inch dimension wood wall stud, floor or ceiling joist by means of a “U” shaped jaw equipped with gripping tangs. The footstep/handgrip end is equipped with a ¾ inch access hole in the slipguard. The outer side of the jaw is equipped with a tapered “V” notch. The first function of the invention is that of a quick, efficient, inexpensive, alternative to a stepladder, scaffold or other means of increasing overhead reach. Second, it provides a handgrip for steadying the user while elevated and working from another device such as this or other vertical stepping device. Third, the invention can also be used as a come-along or prybar on any building material with a 1½ inch dimension such as studs and joists. Inserting a length of pipe into the ¾ inch access hole in the footstep/handgrip improves leverage and enhances this feature. Fourth, when fitted with a length of pipe in same manner and inplace on a stud or joist, the invention serves as a small wire roll spool holder for dispensing wire. Last, when used with the footstep/handgrip as a handle and the V-shape notch in the jaw face, the invention serves as a nail puller and small wire insulation stripper.

It is an object of this invention to disclose an invention which is small, versatile, durable, and inexpensive to manufacture. It is an object of this invention to disclose an invention which uses a gripping jaw, gripping tangs, a footstep/handgrip, and slip guard to grip 1½ inch dimension wall studs, floor or ceiling joists. It is an object of this invention that the invention will grip a stud or joist with the footstep/handgrip facing either left or right, allowing access with either hand or foot. It is an object of this invention that the gripping jaw and tangs will maintain the invention inplace for use yet make it quickly removable. It is an object of this invention that, when used on a vertical stud or joist, the gripping jaw and tangs increase their grip on the stud as increasing weight is applied to the invention footstep/handgrip. It is an object of this invention that the ¾ inch hole in the slipguard provides access into the footstep/handgrip for a length of ¾ inch pipe and enhances the invention's use as a come-along or prybar on studs or joists. It is an object of this invention that inplace on a stud or joist and fitted with a length of pipe inserted into the footstep/handgrip end, the invention will hold spooled wire rolls for dispensing wire. It is an object of this invention that the V-shaped notch in the jaw face and using the footstep/handgrip as a handle, the invention serves as a nail puller and wire insulation stripper.

Various other objects, advantages and features of this invention will become apparent to those skilled in the art from the following description in conjunction with the accompanying drawings.

### VIEWS OF THE DRAWINGS

FIG. 1 is a plan view of the invention. FIG. 2 is an elevation view of the jaw throat side. FIG. 3 is an elevation view from the slipguard end. FIG. 4 is an elevation view from the jaw end. FIG. 5 is a perspective view of the invention in position to be placed on a vertical stud as a footstep, handgrip, prybar or wire roll holder. FIG. 6 is a perspective view in place on a vertical stud as a footstep or handgrip. FIG. 7 is a perspective view in place as a prybar or wire roll holder. FIG. 8 is a perspective view in place as a nail puller. FIG. 9 is a perspective view in place as a wire insulation stripper. Direction of force required to operate the invention are indicated by arrows.

### DESCRIPTION OF THE INVENTION

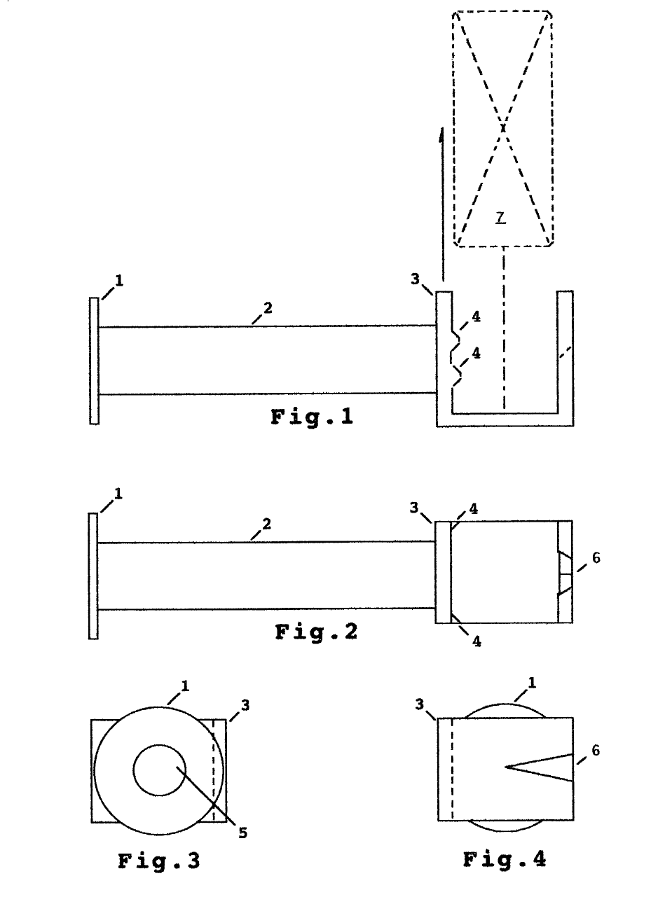

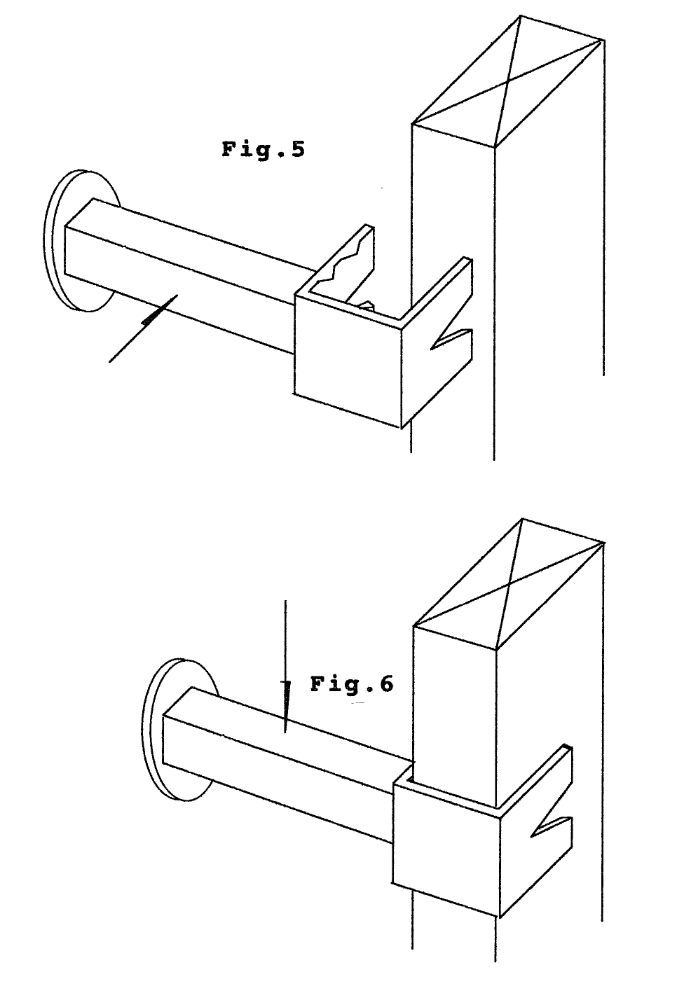

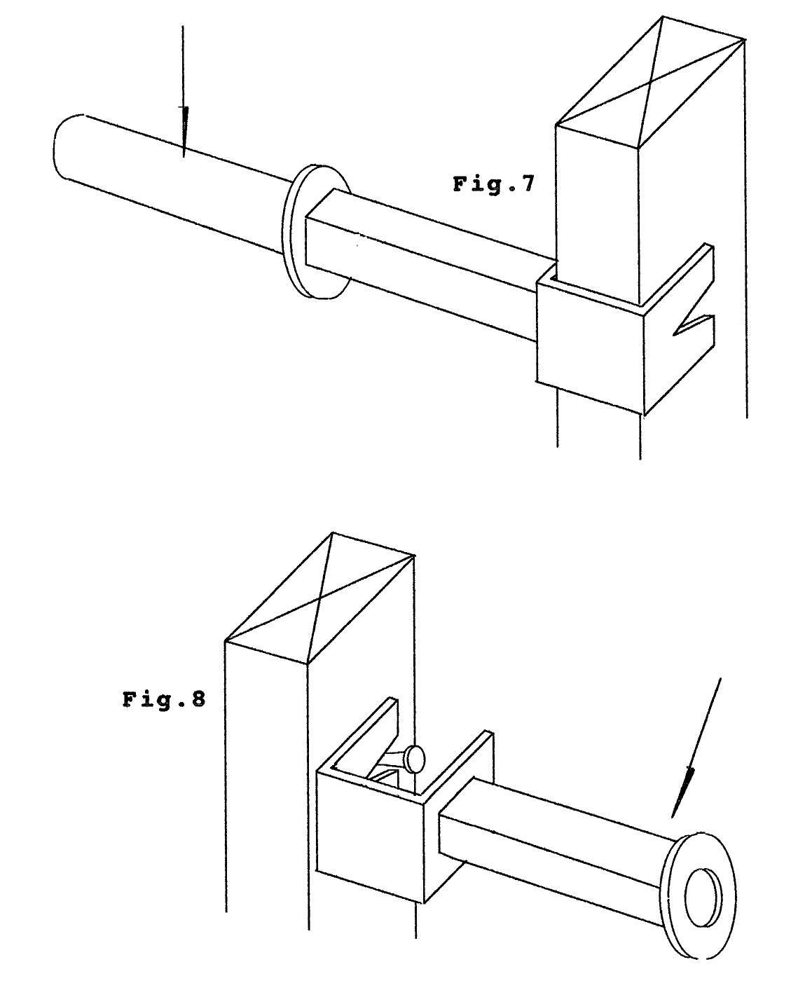

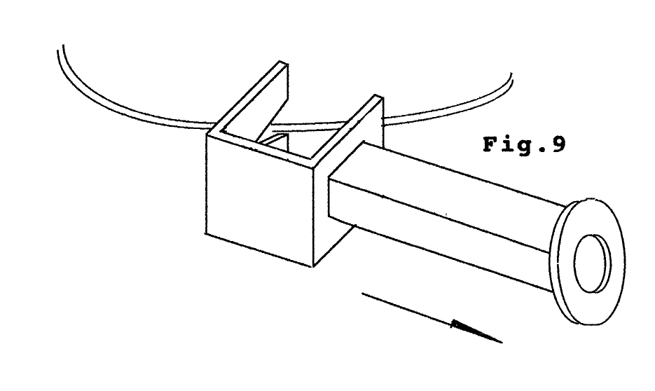

Turning now to the drawings, FIGS. 1 through 4, the invention is constructed of three steel elements welded together. Element 1 is a foot slipguard made from a 2″ steel component, in this drawing a steel wafer washer. Element 2, is a footstep and handgrip of 1″ outside diameter 11 gauge cold rolled steel square tubing 5 inches long. Element 3, is a gripping jaw of ¼ inch cold rolled steel plate pressed into a “U” shape with a 1 9/16 inch opening in the jaw, 1½ inches high and 2 inches deep. Elements 4 are four tapered gripping tangs protruding inward into the inner part of the jaw approximately ¼ inch. Element 5 is a ¾ inch access hole in the end of the footstep/handgrip. Element 6 is a tapered “V” notch.

The washer is laid flat and welded in place on the end of the tube with the ¾ inch center opening 5, of the washer centered over the end opening of the square tube. The other end of the tube is centered on the side of the “U” shaped jaw, equidistant from the ends of the jaw mouth and throat and welded in place. Gripping tangs 4, are made by a point die press which deforms the top and bottom edges of the jaw into tapered tangs protruding inward into the gripping jaw. The tapered “V” notch 6 in the outer face of the jaw is punched or sawed with an approximate 35 degree bevel and 35 degree “V” opening.

As a footstep or handgrip, the invention is placed on and removed from a stud or joist using the footstep/handgrip 2 as a handle. The invention's symmetrical design allows the user to place the invention on the right or left side of the stud or joist, depending on the user's preference to step up or grip the invention with the left or right foot or hand, respectively. The tapered tangs allow the invention to easily slide on/off and hold the invention inplace until force is applied to the footstep/handgrip. FIG. 5 depicts pending placement on the left side of a stud. Once inplace with the back of the jaw 3 firmly seated against the face of the stud 6, as depicted in FIG. 6, the invention grips the stud by means of the jaw's gripping tangs 4 shown in FIGS. 1, 2 and 4. The invention further grips by transferring the force placed on footstep/handgrip 2 into a rotational force to the jaw 3 and the jaw's lower gripping tangs 4 and subsequently a gripping force, to the stud or joist.

Referring to FIG. 2, the footstep/handgrip 2 provides a single step on which the user can stand or a handle which the user can grip. The slipguard 1 prevents the user's foot from slipping when used as a footstep.

Referring to FIG. 3, the ¾ inch hole 5 in the footguard 1 allows for insertion of a ¾ inch prybar into the slipguard and footstep/handgrip. Using the same placement procedure as described in paragraphs 1 and 2 above and used in the configuration described here, the invention becomes a prybar/come-along for any 1½ inch face dimension lumber such as studs or joists. This configuration also serves as a wire roll holder for dispensing wire by placing the pipe through the center of the wire roll, placing the pipe into the end of the invention and placing the invention on a suitable exposed 1½ inch surface as in FIGS. 5 and 6.

While the invention has been described with preferred specific embodiments thereof, it will be understood that this description is intended to illustrate and not limit the scope of the invention.

I claim:

1) What I claim as my invention is a handheld invention which is compact, sturdy, quick, efficient, inexpensive, and consolidates the tool and equipment functions of a stepladder, scaffold or other means of increasing overhead reach; a handgrip device; and when used with a steel bar placed in the end of the footstep/handgrip, a hand prybar, wire roll dispenser, nail puller and wire insulation stripper. The invention comprises:
a gripping jaw dimensioned to snuggly fit over the face of a vertical 1½ inch face dimension lumber stud “2×” and grip it when force is applied to the footstep/handgrip;
gripping jaw teeth which hold the invention inplace until force is applied to the footstep/handgrip;
gripping jaw teeth which assist in gripping when force is applied to the footstep/handgrip;
a footstep/handgrip for placement, use and removal of the invention;
a footguard to prevent foot slippage.

2) An invention as in claim 1 wherein the footstep of the invention is also a handgrip handle to position the invention for use and removal;

3) An invention as in claim 1 wherein the symmetric design of the gripping jaw, gripping teeth, and footstep/handgrip provides the user left or right hand or foot access;

4) An invention as in claim 1 wherein the footstep/handgrip, because of placement transversely from the gripping jaw and teeth, transfers the user's force to pivotal gripping force on the stud or joist through the gripping jaw and gripping teeth.

5) An invention as in claim 4 wherein the gripping teeth provide initial gripping force to the stud to hold the invention in place until user weight is applied to the step;

6) An invention as in claim 5 wherein a footguard prevents foot slippage from the invention and provides access to the inside of the footstep/handgrip for placing a steel bar;

7) An invention as in claim 6 wherein an access hole provides placement of a steel bar inside the footstep/handgrip enhancing prybar leverage;

8) An invention as in claim 6 wherein an access hold provides placement of a steel bar inside the footstep/handgrip converting the invention into a wire roll holder;

9) An invention as in claim 1 wherein a “V” notch in the outer face of the jaw functions as a nail puller;

10) An invention as in claim 1 wherein a “V” notch in the outer face of the jaw functions as a wire insulation stripper.
